(19) United States
(12) Patent Application Publication
(10) Pub. No.: US 2017/0037736 A1
(43) Pub. Date: Feb. 9, 2017

(54) WHEEL DISK ASSEMBLY AND METHOD FOR ASSEMBLING A WHEEL DISK ASSEMBLY

(71) Applicant: Siemens Aktiengesellschaft, Munich (DE)

(72) Inventors: Sascha Dungs, Wesel (DE); Harald Hoell, Wächtersbach (DE); Kevin Kampka, Mülheim a. d. Ruhr (DE); Karsten Kolk, Mülheim a.d. Ruhr (DE); Marc Lange, Köln (DE); Peter Schröder, Essen (DE); Vyacheslav Veitsman, Gelsenkirchen (DE)

(73) Assignee: Siemens Aktiengesellschaft, Munich (DE)

(21) Appl. No.: 15/304,591

(22) PCT Filed: Mar. 31, 2015
(86) PCT No.: PCT/EP2015/057053

§ 371 Date: Oct. 17, 2016

(30) Foreign Application Priority Data
Apr. 29, 2014 (EP) 14166363.3

(51) Int. Cl. F01D 5/30; F01D 11/00

(52) U.S. Cl. CPC F01D 5/3015; F01D 11/006; F05D 2230/60

(57) ABSTRACT

A wheel disk assembly, having a wheel disk, a plurality of blade devices, which are fastened along the outer circumference of the wheel disk, and a plurality of sealing plates, which are retained in two annular grooves radially spaced apart from each other, the first annular groove in the wheel disk and bounded axially outward by an annular projection, and the second annular groove defined by a plurality of annular-groove segments arranged adjacently, which are in the individual blade devices. At least one opening extends axially through the annular projection, the minimum width of which opening in the circumferential direction is greater than the width of the sealing plates at the inside diameter such that a sealing plate is axially insertable between the annular grooves through the opening and moveable in the circumferential direction while guided by the annular grooves. A method assembles such a wheel disk assembly.

### CROSS REFERENCE TO RELATED APPLICATIONS

This application is the US National Stage of International Application No. PCT/EP2015/057053 filed Mar. 31, 2015, and claims the benefit thereof. The International Application claims the benefit of European Application No. EP14166363 filed Apr. 29, 2014. All of the applications are incorporated by reference herein in their entirety.

### FIELD OF INVENTION

The present invention relates to a wheel disk arrangement having a wheel disk, multiple blade devices which are fastened along the outer circumference of the wheel disk, and multiple sealing plates which are held in two annular grooves spaced radially apart from each other, wherein the first annular groove is provided in the wheel disk and delimited axially outward by an annular projection, and wherein the second annular groove is defined by multiple annular groove segments which are arranged adjacent to one another and provided in each case in the individual blade devices.

### BACKGROUND OF INVENTION

Wheel disk arrangements of the type mentioned at the beginning are known from the prior art in different embodiments. During the mounting, the blade devices are pushed into grooves of the wheel disk, wherein the sealing plates are also inserted successively into the two annular grooves. In order to be able to install the last two blade devices, all the sealing plates must already be mounted and moved so far over their overlapping regions in the annular grooves that the blade devices can be installed in the associated grooves of the wheel disk. The sealing plates are then moved again in the circumferential direction back into their proper position and suitably secured against displacement.

A disadvantage of the known wheel disk arrangements consists in it being possible to dismount the sealing plates for servicing only with difficulty because two adjacent blade devices need to have been removed first, which in practice incurs considerable expense.

A further wheel disk arrangement is disclosed in the document GB 905 582 A.

### SUMMARY OF INVENTION

Starting from this prior art, an object of the present invention is to provide a wheel disk arrangement of the type mentioned at the beginning, in which the sealing plates can be dismounted and remounted easily.

In order to achieve this object, the present invention provides a wheel disk arrangement of the type mentioned at the beginning, in which at least one recess extending axially through the annular projection is provided, the minimum width of which in the circumferential direction is greater than the width of the sealing plates at the internal diameter such that a sealing plate can be inserted axially through the recess between the annular grooves and guided in the circumferential direction by the latter. By virtue of such a recess, the sealing plates can be threaded easily into the associated annular grooves, even when all the blade devices are already mounted on the wheel disk, as a result of which the mounting takes a very flexible form. The individual sealing plates can also be removed again for servicing without any problem through the recess without great expense. According to the invention, at least one closing piece is provided which is designed to be fastened detachably to the wheel disk in order to close the at least one recess. Such a closing piece ensures that the sealing plates arranged in the region of the recess cannot move axially during operation.

According to an embodiment of the present invention, two recesses are provided which are designed to be positioned opposite each other in the wheel disk. Owing to a circumferential offset of the recesses, in particular by 180°, the mounting and dismounting of the sealing plates are on the one hand facilitated. Moreover, a potential imbalance is compensated by the provision of a second recess arranged opposite the first recess.

At least one closing piece is advantageously provided which can be fastened detachably to the wheel disk in order to close a recess. Such a closing piece ensures that the sealing plates arranged in the region of the recess cannot move axially during operation.

The closing piece advantageously has projections which engage in correspondingly designed pockets of the recess in the properly configured state. In this way, the closing piece is fixed axially or radially in the recess in the properly configured state.

According to an alternative of the present invention, the pockets extend axially through the whole annular projection and form undercuts in the radial direction. The closing piece can correspondingly be inserted axially into the recess when the projections are introduced into the associated pockets.

For the purpose of axially fixing the closing piece in its proper position, said closing piece can be caulked to the wheel disk by, for example, material of the closing piece being deformed into cutouts provided for this purpose adjoining the recess.

According to a further alternative of the present invention, the pockets extend from that side of the recess which faces the first annular groove in the properly configured state, axially through a part of the annular projection, and form undercuts in the radial direction. A closing piece with correspondingly designed projections can then be inserted radially into the first annular groove provided on the wheel disk and then be moved axially toward the annular projection with the projections introduced into the associated pockets until the projections come to bear against the walls delimiting the pockets.

For the purpose of axial fixing, according to the invention a filling piece can be provided which is arranged adjacent to the closing piece in the properly configured state and defines a part of the groove base of the first annular groove. In the properly configured state, the filling piece is secured radially by a sealing plate and prevents axial movement of the closing piece.

According to a further alternative of the present invention, the pockets extend radially through the annular projection and form undercuts in the axial direction, wherein the closing piece has a filling piece portion which, in the properly configured state, defines a part of the groove base of the first annular groove. A closing piece with correspondingly designed projections is then, in the properly configured state, secured axially by the projections received in the pockets and radially by a sealing plate which is arranged between the filling piece portion and the second annular groove.

Moreover, the present invention provides a method for mounting a wheel disk arrangement according to the invention, in which, in a first step, all the blade devices are fastened on the outer circumference of the wheel disk in their proper positions and, in a subsequent step, the sealing plates are mounted.

### BRIEF DESCRIPTION OF THE DRAWINGS

Other features and advantages of the present invention will become clear with the aid of the following description of multiple embodiments of wheel disks according to the invention with reference to the attached drawings, in which:

FIG. 1 is a perspective view of a wheel disk arrangement according to a first embodiment of the present invention in the completely mounted state;

FIG. 2 is a perspective partial view of a wheel disk of the wheel disk arrangement shown in FIG. 1, which partial view shows a region of the wheel disk which is provided with a recess;

FIG. 3 is a perspective partial view of the wheel disk arrangement shown in FIG. 1 in the partially mounted state;

FIG. 4 is a perspective view of a closing piece of the wheel disk arrangement shown in FIG. 1 which serves to close the recess shown in FIGS. 2 and 3;

FIG. 5 is a perspective partial view of the wheel disk arrangement shown in FIG. 1 in the completely mounted state;

FIG. 6 shows an enlarged perspective view of the wheel disk arrangement shown in FIG. 5 in the region of the recess closed with the closing piece;

FIG. 7 is a perspective partial view of a wheel disk arrangement according to a second embodiment of the present invention in the completely mounted state;

FIG. 8 is a perspective partial view of a wheel disk of the wheel disk arrangement shown in FIG. 7, which shows a region of the wheel disk provided with a recess;

FIG. 9 is a perspective partial view of the wheel disk arrangement shown in FIG. 7 in the partially mounted state;

FIG. 10 is a perspective view of a closing piece of the wheel disk shown in FIG. 7 which serves to close the recess shown in FIGS. 8 and 9;

FIG. 11 is a perspective view of a filling piece of the wheel disk arrangement shown in FIG. 7;

FIG. 12 is a perspective partial view of the wheel disk arrangement shown in FIG. 7 in the completely mounted state;

FIG. 13 is a perspective cutaway partial view of the wheel disk arrangement shown in FIG. 7 in the completely mounted state, wherein the plane of section extends through the recess;

FIG. 14 is a perspective view of a wheel disk arrangement according to a third embodiment of the present invention in the completely mounted state;

FIG. 15 is a perspective partial view of a wheel disk of the wheel disk arrangement shown in FIG. 14 which shows a region of the wheel disk which is provided with a recess;

FIG. 16 is a perspective partial view of the wheel disk arrangement shown in FIG. 14 in the partially mounted state;

FIG. 17 is a perspective view of a closing piece of the wheel disk arrangement shown in FIG. 14 which serves to close the recess shown in FIGS. 15 and 16;

FIG. 18 is a partial view in cross-section of the wheel disk arrangement shown in FIG. 14 in the completely mounted state; and

FIG. 19 is a perspective view of an alternative closing piece.

### DETAILED DESCRIPTION OF INVENTION

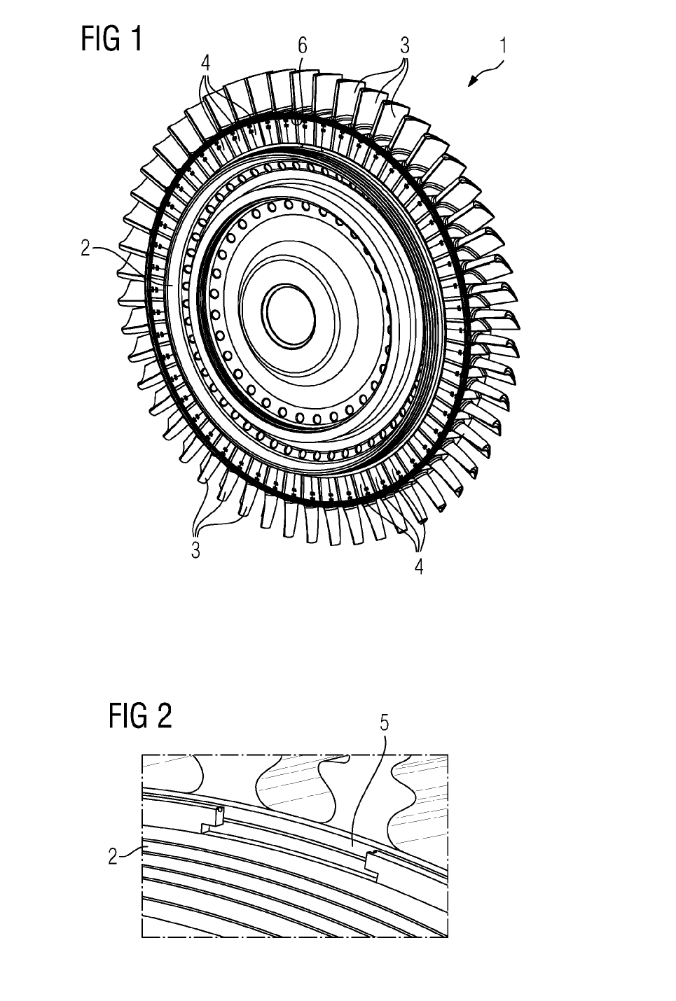

FIGS. 1 to 6 show a wheel disk arrangement 1 according to a first embodiment of the present invention. The wheel disk arrangement 1 comprises a wheel disk 2, multiple blade devices 3 which are fastened along the outer circumference of the wheel disk 2, and multiple sealing plates 4 which are held between the wheel disk 2 and the blade devices 3 in two annular grooves 5 and 6 spaced apart from each other radially. The first annular groove 5 is here provided in the wheel disk 2 and is delimited axially outward by an annular projection 7. The second annular groove 6 is defined by multiple annular groove segments which are arranged adjacent to one another and formed in each case in the blade devices 3.

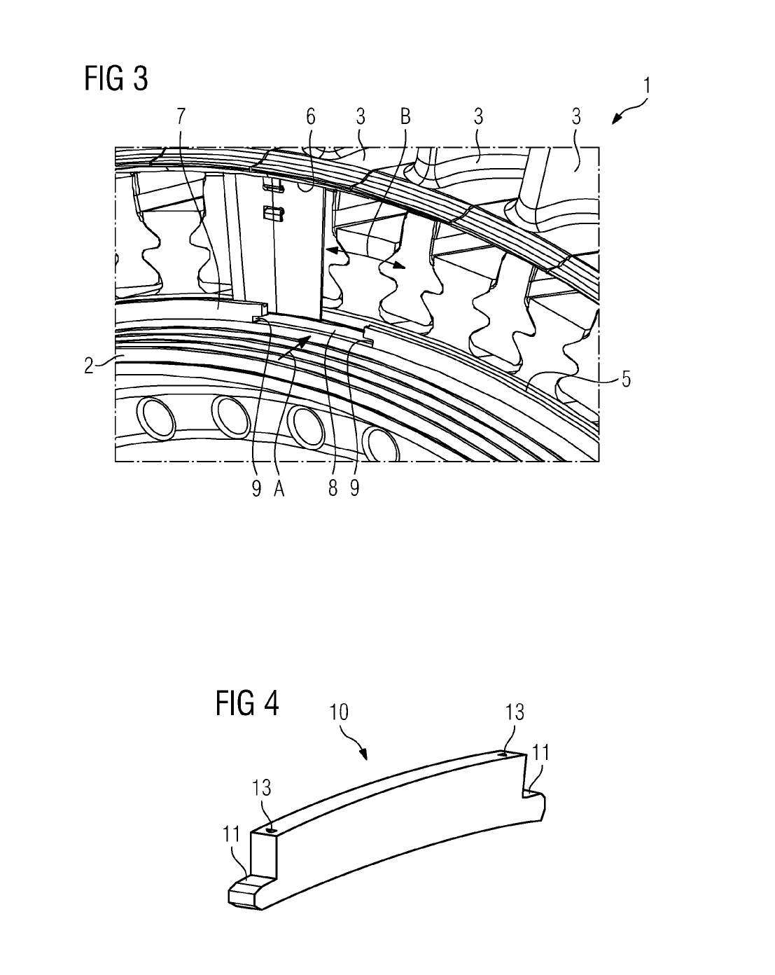

In order to facilitate the mounting of the sealing plates 4, the wheel disk 2 comprises at least one recess 8 which extends axially through the annular projection 7 and the minimum width of which in the circumferential direction is greater than the width of the sealing plates 4 at the internal diameter. A sealing plate 4 can correspondingly be inserted axially through the recess 8 between the annular grooves 5 and 6 and moved in the circumferential direction, guided by the latter, as indicated in FIG. 3 by the arrows A and B. The recess 8 comprises two laterally arranged pockets 9 which extend axially through the whole annular projection 7 and form undercuts in the radial direction.

In order to close the recess 8, the wheel disk arrangement 1 moreover comprises a closing piece 10 which can be fastened detachably on the wheel disk. The closing piece 10 has projections 11 which protrude laterally and are formed correspondingly with the pockets 9 of the recess 8. The closing piece 10 can correspondingly be introduced axially into the recess 8, wherein the projections 11 engage in the associated pockets 9, as a result of which radial fixing of the closing piece 10 received in the recess 8 is obtained.

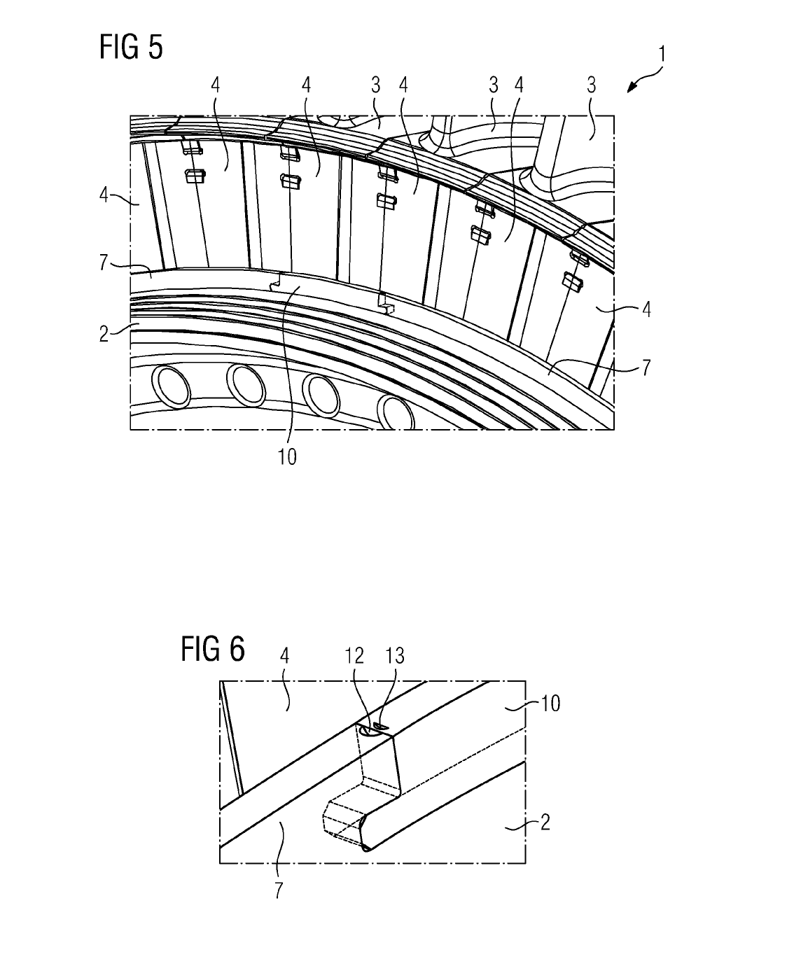

In order to axially fix the closing piece 10 in its proper position, it can be caulked onto the wheel disk 2 by material of the closing piece 10 being deformed, when force is exerted, into cutouts 12 provided for this purpose adjoining the recess 8, as shown in FIG. 6. For this purpose, depressions 13 are provided at the edges on the top of the closing piece 10 in order to receive a caulking tool.

In order to mount the wheel disk arrangement 1 shown in FIG. 1, in a first step all the blade devices 3 are fastened in a known fashion to the wheel disk 2. The individual sealing plates 4 of the row are then introduced axially through the recess 8 into the annular grooves 5 and 6 and then moved in the circumferential direction into their proper position. Those sealing plates 4 which are intended to be arranged in their proper position in the region of the recess 8 are thus positioned directly adjacent to the recess 8. After the insertion of all the sealing plates 4, the closing piece 10 is inserted axially into the recess 8. A caulking tool is introduced into the depressions 13, whereupon material of the closing piece is deformed, when subjected to force, into the cutouts 12. The closing piece 10 is now secured radially and axially on the wheel disk 2. In a further step, the last sealing plates 4 are also moved into their proper position, whereupon the individual sealing plates 4 are fixed with suitable means in their proper position in order to prevent undesired movement in the circumferential direction.

It should be clear that the wheel disk arrangement 1 can also have multiple recesses 8 with associated closing pieces 10. Thus, for example, two recesses 8 can be provided in the wheel disk 2 which are designed opposite each other, offset by 180°. In this way, on the one hand, the mounting or dismounting of the sealing plates 4 can be simplified and, on the other hand, imbalances can be eliminated.

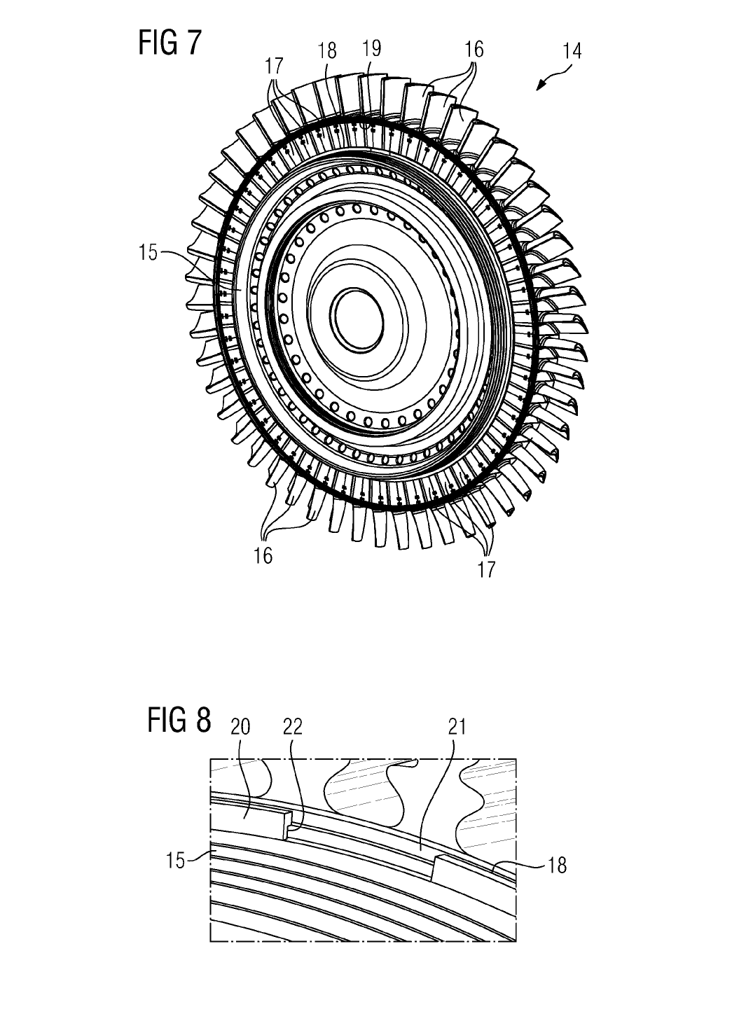

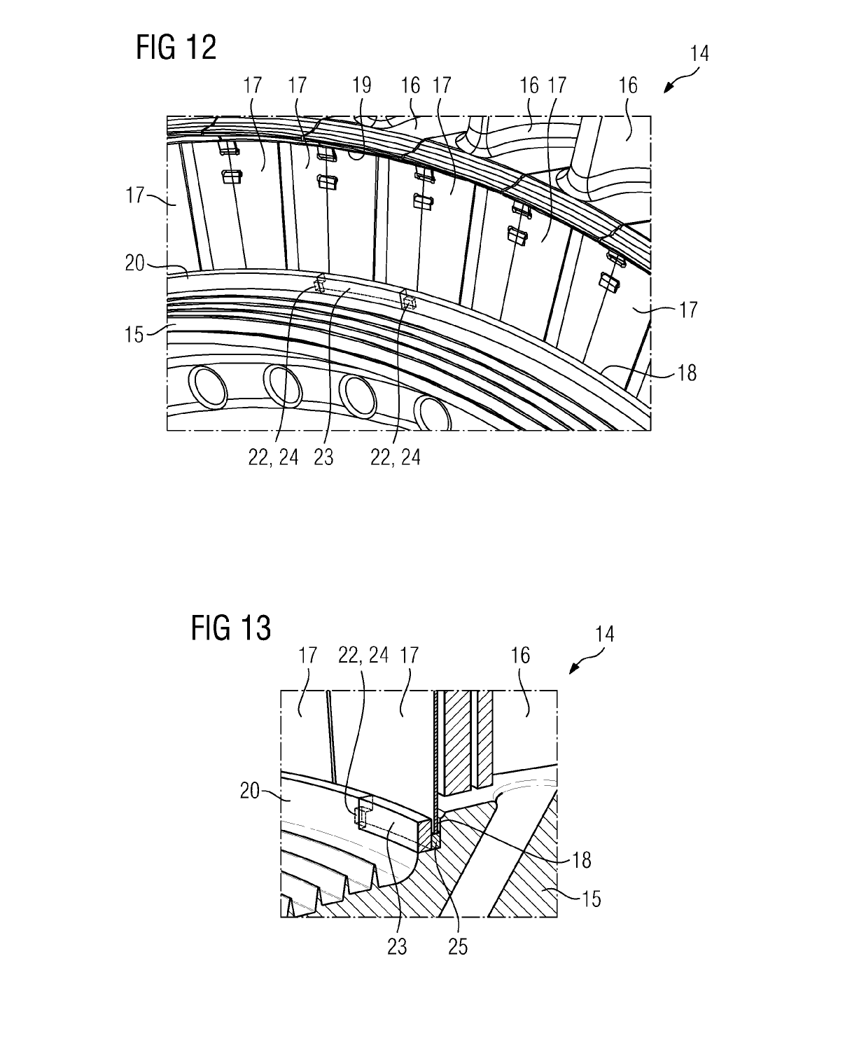

FIGS. 7 to 13 show a wheel disk arrangement 14 according to a second embodiment of the present invention. The wheel disk arrangement 14 comprises a wheel disk 15, multiple blade devices 16 which are fastened along the outer circumference of the wheel disk 15, and multiple sealing plates 17 which are held between the wheel disk 15 and the blade devices 16 in two annular grooves 18 and 19 spaced apart radially from each other. The first annular groove 18 is here provided in the wheel disk 15 and is delimited axially outward by an annular projection 20. The second annular groove 19 is defined by multiple adjacently arranged annular groove segments which are each designed in the blade devices 16.

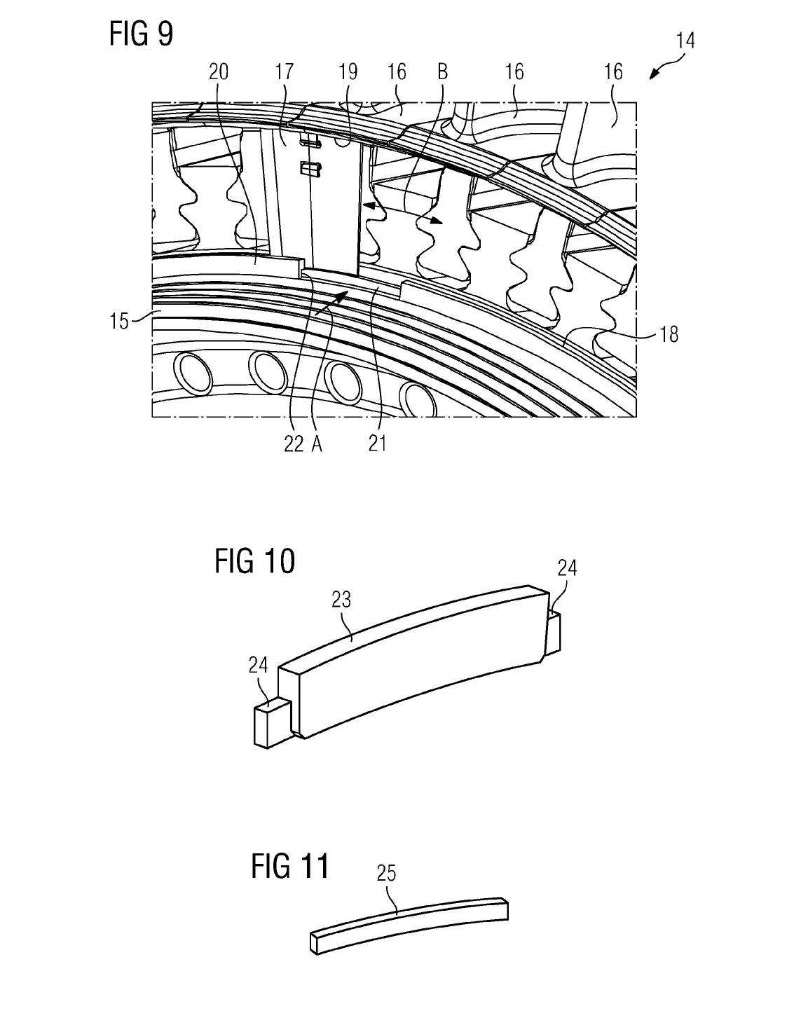

In order to facilitate the mounting of the sealing plates 17, the wheel disk 15 comprises at least one recess 21 extending axially through the annular projection 20 and the minimum width of which in the circumferential direction is greater than the width of the sealing plates 17 at the internal diameter. Correspondingly, a sealing plate 17 can be inserted axially through the recess 21 between the annular grooves 18 and 19 and moved in the circumferential direction, guided by the latter, as indicated in FIG. 9 by the arrows A and B. The recess 21 comprises two laterally arranged pockets 22 which, starting from that side of the recess which faces the groove in the properly configured state, extend axially through a part of the annular projection 20 and form undercuts in the radial direction.

In order to close the recess 21, the wheel disk arrangement 14 moreover comprises a closing piece 23 which can be fastened detachably to the wheel disk 15. The closing piece 23 has projections 24 which protrude laterally and are designed so that they correspond with the pockets 22 of the recess 21. The closing piece 10 can correspondingly be inserted radially into the first annular groove 18 and be introduced in an axial direction into the recess 21, the projections 24 engaging in the associated pockets 22, as a result of which radial fixing of the closing piece 23 received in the recess 21 is achieved.

In order to axially fix the closing piece 10 in its proper position, a filling piece is provided which, in the properly configured state, is arranged adjacent to the closing piece and defines a part of the groove base of the first annular groove 18. The filling piece is in the present case designed in the form of a circular ring segment and has a rectangular cross-section.

In order to mount the wheel disk arrangement 14 shown in FIG. 7, in a first step all the blade devices 16 are fastened in a known fashion to the wheel disk 15. The individual sealing plates 17 of the row are then introduced axially through the recess 21 into the annular grooves 18 and 19 and then moved in the circumferential direction into their proper position. Those sealing plates 17 which are intended to be arranged in their proper position in the region of the recess 21 are thus positioned directly adjacent to the recess 21. After the sealing plates 17 have been inserted, the closing piece 23 is inserted radially into the first annular groove 18 and then pushed axially into the recess 21. The filling piece is then inserted radially into the first annular groove 18. In a further step, the last sealing plates are moved into their proper position, whereupon the individual sealing plates 17 are fixed with suitable means in their proper position, in order to prevent undesired movement in the circumferential direction. The closing piece 23 is now fixed radially and axially.

It should be clear that the wheel disk arrangement 14 can also have multiple recesses 21 with associated closing pieces 23 and filling pieces 25. Thus, for example, two recesses 21 can be provided which are designed in the wheel disk 15 opposite each other, offset by 180°. In this way, on the one hand, the mounting or dismounting of the sealing plates 17 can be simplified and, on the other hand imbalances can be eliminated.

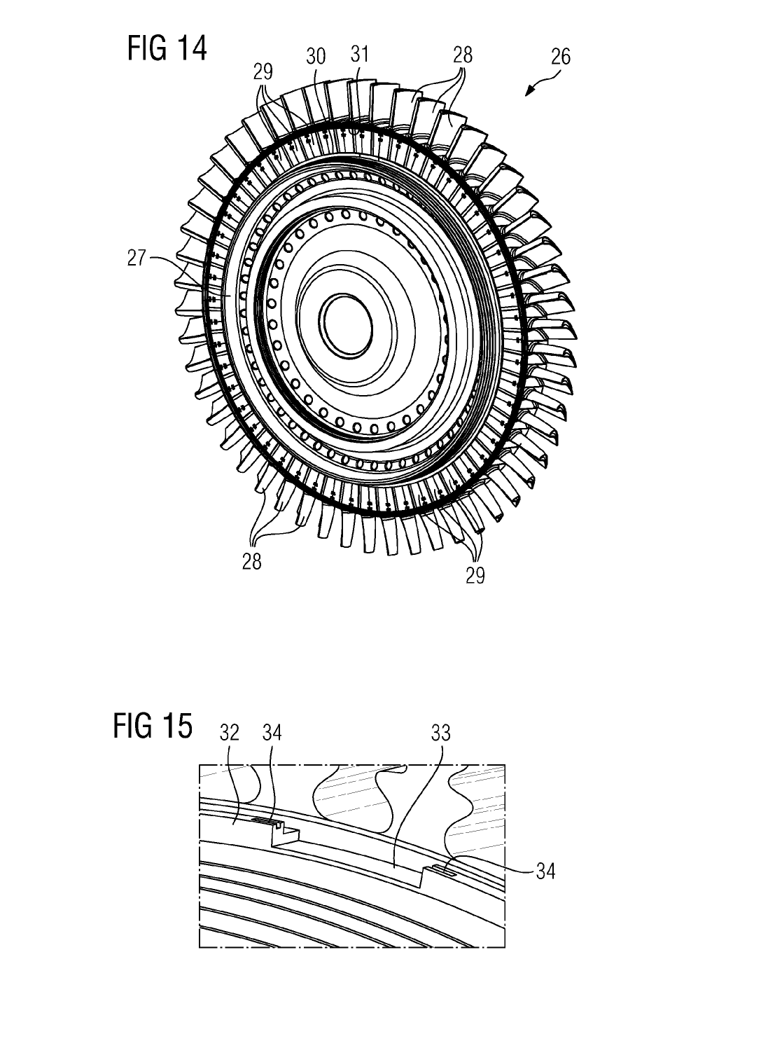

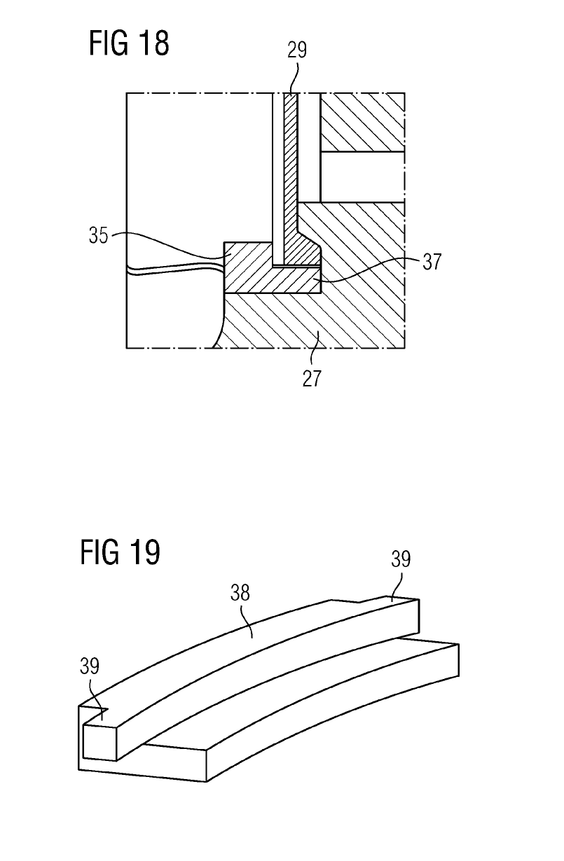

FIGS. 14 to 18 show a wheel disk arrangement 26 according to a third embodiment of the present invention. The wheel disk arrangement 26 comprises a wheel disk 27, multiple blade devices 28 which are fastened along the outer circumference of the wheel disk 27, and multiple sealing plates 29 which are held between the wheel disk 27 and the blade devices 28 in two annular grooves 30 and 31 spaced apart radially from each other. The first annular groove 30 is here provided in the wheel disk 27 and is delimited axially outward by an annular projection 32. The second annular groove 31 is defined by multiple adjacently arranged annular groove segments which are each designed in the blade devices 28.

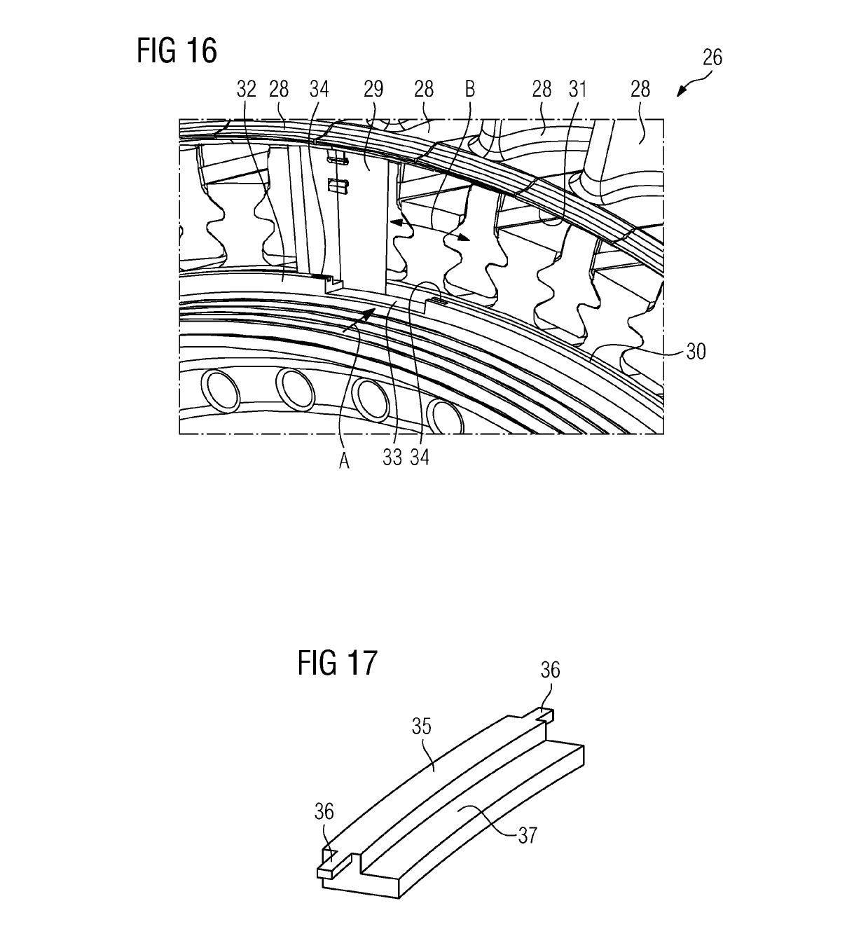

In order to facilitate the mounting of the sealing plates 29, the wheel disk 27 comprises at least one recess 33 extending axially through the annular projection 32 and the minimum width of which in the circumferential direction is greater than the width of the sealing plates 29 at the internal diameter. Correspondingly, a sealing plate 29 can be inserted axially through the recess 33 between the annular grooves 30 and 31 and moved in the circumferential direction, guided by the latter, as indicated in FIG. 16 by the arrows A and B. The recess 33 comprises two laterally arranged pockets 34 which, starting from the top of the annular projection 32, extend radially through the annular projection 32 and form undercuts in the axial direction.

In order to close the recess 33, the wheel disk arrangement 26 moreover comprises a closing piece 35 which can be fastened detachably to the wheel disk 27. The closing piece 35 has projections 36 which protrude laterally and are designed so that they correspond with the pockets 34 of the recess 33. The closing piece 35 can correspondingly be introduced in a radial direction into the recess 33, the projections 36 engaging in the associated pockets 34, as a result of which axial fixing of the closing piece 35 received in the recess 33 is achieved. The closing piece 35 moreover has a filling piece portion 37 which, in the properly configured state, defines a part of the groove base of the first annular groove 30.

In order to mount the wheel disk arrangement 26 shown in FIG. 14, in a first step all the blade devices 28 are fastened in a known fashion to the wheel disk 27. The individual sealing plates 29 of the row are then introduced axially through the recess 33 into the annular grooves 30 and 31 and then moved in the circumferential direction into their proper position. Those sealing plates 29 which are intended to be arranged in their proper position in the region of the recess 33 are positioned directly adjacent to the recess 33. After all the sealing plates 29 have been inserted, the closing piece 35 is inserted radially into the recess 33. The last sealing plates are then also moved into their proper position, whereupon the individual sealing plates 29 are fixed with suitable means in their proper position, in order to prevent undesired movement in the circumferential direction.

It should be clear that the wheel disk arrangement 26 can also have multiple recesses 33 with associated closing pieces 35. Thus, for example, two recesses 33 can be provided which are designed in the wheel disk 27 opposite each other, offset by 180°. In this way, on the one hand, the mounting or dismounting of the sealing plates 29 can be simplified and, on the other hand, imbalances can be eliminated.

FIG. 19 shows an alternative closing piece 38 which, instead of the closing piece 35, can be used with a correspondingly designed recess (not shown in detail). The only difference between the closing pieces 38 and 35 is that the position of the projections 39 is selected so that it is not central like that of the projections 36 but situated on the inside.

By virtue of the recesses according to the invention, in the abovedescribed embodiments the sealing plates can be simply threaded into the associated annular grooves, even when all the blade devices are already mounted on the wheel disk, as a result of which the mounting is very flexibly designed. If service is required, the individual sealing plates can also be removed again through the recess easily and without great expense.

Although the invention was described and illustrated in detail by the preferred exemplary embodiment, the invention is not limited by the examples disclosed and other variants can be derived by a person skilled in the art without going beyond the scope of the invention.

What is claimed is:

1. A wheel disk arrangement, comprising:
a wheel disk, multiple blade devices which are fastened along the outer circumference of the wheel disk, and multiple sealing plates which are held in two annular grooves spaced radially apart from each other,
wherein the first annular groove is provided in the wheel disk and delimited axially outward by an annular projection, and
wherein the second annular groove is defined by multiple annular groove segments which are arranged adjacent to one another and provided in each case in the individual blade devices, wherein
at least one recess extending axially through the annular projection, the minimum width of which in the circumferential direction is greater than the width of the sealing plates at the internal diameter such that a sealing plate is insertable axially through the recess between the annular grooves and is guided in the circumferential direction by the latter, and
at least one closing piece which is designed to be fastened detachably to the wheel disk in order to close the at least one recess.

2. The wheel disk arrangement as claimed in claim 1, further comprising:
two recesses which are designed to be positioned opposite each other in the wheel disk.

3. The wheel disk arrangement as claimed in claim 1,
wherein the closing piece has projections which engage in correspondingly designed pockets of the recess in the properly configured state.

4. The wheel disk arrangement as claimed in claim 3,
wherein the pockets extend axially through the whole annular projection and form undercuts in the radial direction.

5. The wheel disk arrangement as claimed in claim 4,
wherein the closing piece in the properly configured state is caulked on the wheel disk.

6. The wheel disk arrangement as claimed in claim 3,
wherein the pockets, starting from that side of the recess which faces the first annular groove in the properly configured state, extend axially through a part of the annular projection and form undercuts in the radial direction.

7. The wheel disk arrangement as claimed in claim 6, further comprising:
a filling piece which is arranged adjacent to the closing piece in the properly configured state and defines a part of the groove base of the first annular groove.

8. The wheel disk arrangement as claimed in claim 1,
wherein the pockets extend radially through the annular projection and form undercuts in the axial direction,
wherein the closing piece has a filling piece portion which, in the properly configured state, defines a part of the groove base of the first annular groove.

9. A method for mounting a wheel disk arrangement as claimed in claim 1,
in which, in a first step, all the blade devices are fastened on the outer circumference of the wheel disk in their proper positions and,
in a subsequent step, the sealing plates are mounted.
